(19) United States
(12) Patent Application Publication
(10) Pub. No.: US 2011/0116640 A1
(43) Pub. Date: May 19, 2011

(54) CONTENT REPRODUCTION SYSTEM AND CONTENT REPRODUCTION METHOD

(75) Inventors: Makoto Matsumaru, Saitama (JP); Kazushi Tahara, Saitama (JP); Toshihiro Sotomaru, Saitama (JP)

(73) Assignee: PIONEER CORPORATION, Kawasaki-shi, Kanagawa (JP)

(21) Appl. No.: 12/936,584

(22) PCT Filed: Apr. 7, 2008
(86) PCT No.: PCT/JP2008/056871

§ 371 Date: Dec. 16, 2010

(51) Int. Cl. H04R 5/00

(52) U.S. Cl. 381/17

(57) ABSTRACT

The contents reproducing system includes a plurality of contents reproducing units, and the delay amount calculating unit calculates the delay amount with which each of the contents reproducing units reproduces the contents data. The delay amount is the time to delay the reproduction of the contents data, for example. The contents reproducing unit reproduces the contents data, by each of the contents reproducing units, with the delay based on the delay amount calculated by the delay amount calculating unit. By automatically controlling the delay amount of the contents data in this manner, the contents reproducing system can create a sound space with wrapped feeling and spreading feeling.

### TECHNICAL FIELD

The present invention relates a contents reproducing method by which a listener can feel wrapped feeling and/or spreading feeling when contents data are simultaneously reproduced from a plurality of contents reproducing units.

### BACKGROUND TECHNIQUE

As a method for the listener to obtain the sound spreading feeling, there are generally known a method of increasing the number of the speakers (e.g., 5.1ch multi-channels) and a method of processing the sound (e.g., effect technique such as reverberation) without increasing the number of the speakers. Other than these, the Patent Document-1 is known in which the amplitude and the delay time are controlled to improve the surrounding feeling.

However, since those cases assume such a conventional audio system that a listener sitting in front of the stereo listens to the music, he or she can feel the sound spreading feeling only in a limited area (e.g., in front of, or at the center of the audio system).

At present, according to the progress of the home network technique such as a power line communication, it is assumed that the listener moves around rooms, and an audio system by which the listener can listen to the music in everywhere in the house is popular. In such an audio system, it is difficult for the listener to obtain the sound spreading feeling by the conventional method. Particularly, in the case of monophonic speakers, there is such a problem that the sound field is located at the center, even if the listener is apart from two speakers by the same distance, and the listener cannot feel wrapped feeling and/or spreading feeling.

As an audio system by which the listener can listen to the music everywhere in the house, there is known the Patent Document-2 in which a speaker is set in each room and the music is reproduced by one of those speakers that detected the listener.

Patent Document-1: Japanese Patent No. 2953347

Patent Document-2: Japanese Patent Application Laid-open under No. 11-306498

### DISCLOSURE OF INVENTION

### Problem to be Solved by the Invention

The above-mentioned one is a problem to be solved by the invention. It is an object of the present invention to provide a contents reproducing system which automatically controls delay amount of contents data by various delay amount calculating method, thereby to create a sound space having wrapped feeling and spreading feeling, when the contents data is simultaneously reproduced from a plurality of contents reproducing units.

### Means for Solving the Problem

The invention described in claim 1 is a contents reproducing system including a plurality of contents reproducing units which reproduces contents data, comprising: a delay amount calculating unit which calculates a delay amount of the contents data reproduced by each of the content reproducing units; and a contents reproducing unit which reproduces the contents data in each of the content reproducing units, based on the delay amount calculated by the delay amount calculating unit.

The invention described in claim 10 is a contents reproducing method executed by a contents reproducing system including a plurality of content reproducing units which reproduces contents data, comprising: a delay amount calculating process which calculates delay amount of the contents data reproduced by each of the content reproducing units; and a contents reproducing process which reproduces the contents data in each of the content reproducing units, based on the delay amount calculated by the delay amount calculating process.

The invention described in claim 11 is a contents reproducing server which communicates with a plurality of content reproducing units which reproduces contents data, comprising: a delay amount calculating unit which calculates delay amounts of the contents data reproduced by each of the contents reproducing units; and a delay amount transmitting unit which transmits delay amount information related to the delay amount calculated by the delay amount calculating unit to each of the contents reproducing terminals.

The invention described in claim 12 is a contents reproducing program executed by a computer which communicates with a plurality of content reproducing terminals which reproduces contents data, the program making the computer function as: a delay amount calculating unit which calculates delay amounts of the contents data reproduced by each of the content reproducing terminals; and a delay amount transmitting unit which transmits delay amount information related to the delay amount calculated by the delay amount calculating unit to each of the contents reproducing terminals.

### BRIEF DESCRIPTION OF THE DRAWINGS

FIG. 1 is a diagram schematically showing a whole configuration of a sound reproducing system.

FIG. 2 is a block diagram showing a functional configuration of a server unit and a terminal unit.

FIG. 3 is a flowchart of sound reproducing processing.

### BRIEF DESCRIPTION OF REFERENCE NUMBERS

1 Sound Reproducing System

2 Network

10 Sound Reproducing Server

12 Sound Reproducing Terminal

100 Server Unit

200 Terminal Unit

### DETAILED DESCRIPTION OF THE PREFERRED EMBODIMENTS

According to one aspect of the present invention, there is provided a contents reproducing system including a plurality of contents reproducing units which reproduces contents data, comprising: a delay amount calculating unit which calculates a delay amount of the contents data reproduced by each of the content reproducing units; and a contents reproducing unit which reproduces the contents data in each of the content reproducing units, based on the delay amount calculated by the delay amount calculating unit.

The contents reproducing system configured as described above has a plurality of contents reproducing units which reproduces the contents data. The contents data is sound data including music data and voice data, for example. The delay amount calculating unit of the contents reproducing system calculates the delay amounts to reproduce the contents data by each of the contents reproducing units. The delay amount is the time of delaying the reproduction of the contents data, for example. The contents reproducing unit reproduces the contents data, with delaying the contents data by each of the contents reproducing unit, respectively, based on the delay amounts calculated by the delay amount calculating unit. By automatically controlling the delay amount of the contents data, the contents reproducing system can create a sound space with wrapped feeling and spreading feeling.

According to one mode of the above contents reproducing system, each of the contents reproducing units includes a person detecting sensor which detects a person existing within a predetermined range from the contents reproducing unit, the contents reproducing system further comprises a person detecting information generating unit which generates person detecting information when the person detecting sensor detects the person, and the delay amount calculating unit calculates the delay amount of the contents data reproduced by each of the contents reproducing units, based on the person detecting information. By this, each of the contents reproducing units has the person detecting sensor, and the person detecting information generating unit generates the person detecting information when the person detecting sensor detects the person. The delay amount calculating unit calculates the delay amount of the contents data reproduced by each of the contents reproducing units based on the person detecting information generated by the person detecting information generating unit. Namely, the delay amount calculating unit calculates the delay amount of the contents data reproduced by the contents reproducing unit in consideration of the position of the person, particularly the distance between the contents reproducing unit and the person. By automatically controlling the delay amount of the contents data in consideration of the distance between the contents reproducing unit and the person, the contents reproducing system can create a sound space with wrapped feeling and spreading feeling.

According to another mode of the above contents reproducing system, the delay amount calculating unit determines the delay amount of the contents data reproduced by the contents reproducing unit having a shortest distance from the person to be zero and calculates the delay amount of the contents data reproduced by the contents reproducing unit having a longer distance from the person to be large, based on plural person detecting information. By this, in the contents reproducing system, the contents data is reproduced without delay by the contents reproducing unit having a shortest distance from the person. In the other contents reproducing units, the delay time is set to be larger as the distance from the person is longer, and the contents data is reproduced with largest delay by the contents reproducing unit having a longest distance from the person. Thus, the person can constantly listen to the contents having wrapped feeling and spreading feeling, even if the person moves.

According to still another mode, the above contents reproducing system further comprises a distance calculating unit which calculates the distances between each of the contents reproducing units, and the delay amount calculating unit calculates the delay amount of the contents data reproduced by each of the contents reproducing units based on the distances between each of the contents reproducing units, calculated by the distance calculating unit, and the person detecting information. By this, the delay amount calculating unit calculates the delay amount of the contents data reproduced by each of the contents reproducing units in consideration of, not only the distance between the contents reproducing unit and the person, but also the distances between the contents reproducing units. Therefore, each of the contents reproducing units reproduces the contents based on the delay amount considering the distances between the contents reproducing units. By this, the contents reproducing system can constantly provide a listening space of a broad sound field, even in the person moves.

According to still another mode, the above contents reproducing system further comprises a contents data analyzing unit which analyses the contents data, and the delay amount calculating unit determines the delay amount to be zero in a determination of voice data and calculates a small delay amount for the contents data, a beat number and an average sound pressure value of which is high, and a large delay amount for the contents data, the beat number and the average sound pressure value of which is low, in the determination of music data, based on the result of the analysis by the contents data analyzing unit. The small delay amount includes the delay amount of zero, i.e., with no delay. By this, the delay amount calculating unit can calculate the delay amount of the contents data reproduced by each of the contents reproducing units in consideration of the musical characteristic amount of the contents data. For example, since the delay amount is calculated to be large for the classic music with weak beat, it is possible to provide an accurate listening space in consideration of the contents to be listened to.

According to still another mode, the contents reproducing system further comprises a volume detecting unit which detects a volume with which the contents data are reproduced, and the delay amount calculating unit calculates a small delay amount for the contents data reproduced by a large volume and calculates a large delay amount for the contents data reproduced by a small volume, based on the volume detected by the volume detecting unit. By this, the delay amount calculating unit can calculate the delay amount of the contents data reproduced by each of the contents reproducing units in consideration of the reproducing volume of the contents data. For example, the delay amount is calculated to be large if the volume is small because the contents data is assumed to be listened to as BGM, and the delay amount is calculated to be small if the volume is large because it is assumed that the listener concentrated is listening. Therefore, it is possible to provide an accurate listening space in consideration of the situation in which the person is listening.

According to still another mode, the contents reproducing system further comprises a time zone detecting unit which detects a time zone, based on a time when the contents data are reproduced, by referring to a table in which a morning time zone and a night time zone are corresponded to time, in advance, and the delay amount calculating unit calculate a small delay amount for the contents data reproduced in the morning time zone and calculates a large delay amount for the contents data reproduced in the night time zone, based on the time zone detected by the time zone detecting unit. By this, the delay amount calculating unit can calculate the delay amount of the contents data reproduced by each of the contents reproducing units in consideration of the time zone in which the contents data are reproduced. Therefore, the delay amount of the contents data is calculated to be small in the morning time zone for the refreshment, and the delay amount of the contents data is calculated to be large in the night time zone for the relaxation. Therefore, it is possible to provide an accurate listening space in consideration of the time zone in which the person is listening to the contents.

According to still another mode of the contents reproducing system, the delay amount calculating unit calculates the delay amount of the contents data reproduced by each of the contents reproducing units based on a number of the contents reproducing units. By this, the delay amount calculating unit can easily calculate the delay amount of the contents data reproduced by each of the contents reproducing units based on the number of the contents reproducing units.

According to still another mode of the contents reproducing system, the delay amount calculating unit calculates the delay amount of the contents data reproduced by each of the contents reproducing units based on the delay amount designated in advance. By this, the contents reproducing system can reproduce the contents data from each of the contents reproducing units based on the delay amount designated in advance.

According to another aspect of the invention, there is provided a contents reproducing method executed by a contents reproducing system including a plurality of content reproducing units which reproduces contents data, comprising: a delay amount calculating process which calculates delay amount of the contents data reproduced by each of the content reproducing units; and a contents reproducing process which reproduces the contents data in each of the content reproducing units, based on the delay amount calculated by the delay amount calculating process. By the contents reproducing method, the delay amount of the contents can be automatically controlled, and the sound space with wrapped feeling and spreading feeling can be created.

According to still another aspect of the invention, there is provided a contents reproducing server which communicates with a plurality of content reproducing units which reproduces contents data, comprising: a delay amount calculating unit which calculates delay amounts of the contents data reproduced by each of the contents reproducing units; and a delay amount transmitting unit which transmits delay amount information related to the delay amount calculated by the delay amount calculating unit to each of the contents reproducing terminals. The above contents reproducing sever calculates the delay amount of the contents data, and transmits the delay amount information related to the delay amount to each of the contents reproducing terminals. Therefore, when each of the contents reproducing terminals reproduces the contents data based on the delay amount information, the sound space with wrapped feeling and spreading feeling can be created.

According to still another aspect of the invention, there is provided a contents reproducing program executed by a computer which communicates with a plurality of content reproducing terminals which reproduces contents data, the program making the computer function as: a delay amount calculating unit which calculates delay amounts of the contents data reproduced by each of the content reproducing terminals; and a delay amount transmitting unit which transmits delay amount information related to the delay amount calculated by the delay amount calculating unit to each of the contents reproducing terminals. By executing the above contents reproducing program on the computer, it is possible to automatically calculate the delay amount and thereby to create a sound space with wrapped feeling and spreading feeling.

### EMBODIMENT

A preferred embodiment of the present invention will be described below with reference to the attached drawings.

[Basic Configuration]

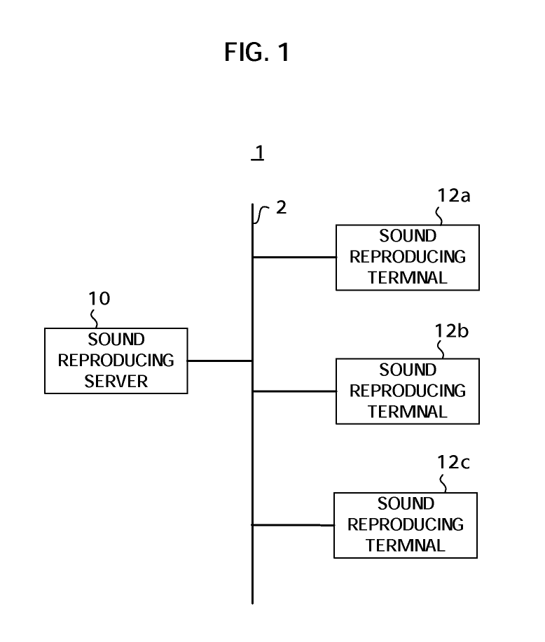

FIG. 1 shows a whole configuration of a sound reproducing system according an embodiment of the present invention. As shown, the sound reproducing system 1 automatically controls delay amount to provide a sound space having wrapped feeling and spreading feeling, even if a listener moves anywhere, when a single contents data stored in a sound reproducing server 10 is simultaneously reproduced by a plurality of sound reproducing terminals 12. The contents data is sound data including music data and voice data, for example. In this embodiment, the sound data is taken as an example. It is noted that the sound reproducing terminal serves as both the contents reproducing terminal and the contents reproducing unit according to the present invention.

In this embodiment, the sound reproducing system 1 includes the sound reproducing server 10, a sound reproducing terminal 12a, a sound reproducing terminal 12b and a sound reproducing terminal 12c, which are connected to each other via a network 2 to communicate with each other. A preferred example of the network 2 is a high-speed power line communication or a wireless LAN. The sound reproducing server 10 is a server which controls plural sound reproducing terminals 12, and includes a CPU and memories necessary for the control. The sound reproducing terminal 12 is a client which outputs sound by reproducing the sound data, and includes a CPU, memories and a sound output units necessary for the reproduction of the sound data. Specifically, the sound output unit includes a D/A converter which performs D/A conversion of the sound data, which is digital data, an amplifier which amplifies an audio analog signal outputted from the D/A converter, and speakers which convert the amplified audio analog signal to sound and output the sound. Also, the sound reproducing terminal 12 includes a person detecting sensor which detects a person existing in a predetermined range from the sensor itself. An example of the person detecting sensor utilizes infrared rays. Since the person detecting sensor is known technique, the detailed description thereof will be omitted for the sake of convenience.

In this embodiment, the sound reproducing system 1 is set in a single home. It is assumed that the sound reproducing terminal 12a is set in a living room, the sound reproducing terminal 12b is set in a dining room and the sound reproducing terminal 12c is set in a kitchen.

[Server Unit]

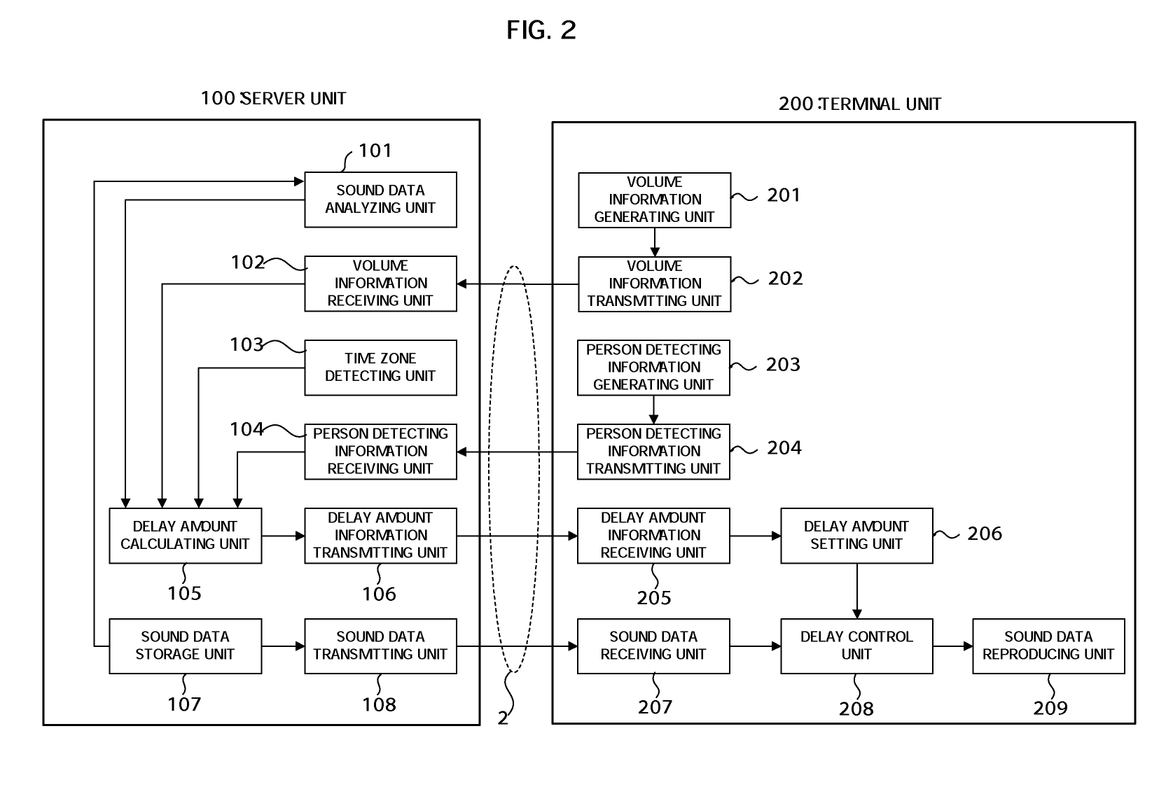

FIG. 2 shows a functional configuration of the server unit 100 and the terminal unit 200, which create a sound space having wrapped feeling and spreading feeling by automatically controlling the delay amounts. The server unit 100 is substantially configured by the constitutional elements of the sound reproducing server 10. As shown, the server unit 100 includes a sound data analyzing unit 101, a volume information receiving unit 102, a time zone detecting unit 103, a person detecting information receiving unit 104, a delay amount calculating unit 105, a delay amount information transmitting unit 106, a sound data storage unit 107 and a sound data transmitting unit 108.

The sound data analyzing unit 101 analyzes the sound data. Specifically, the sound data analyzing unit 101 analyses the sound data stored in the sound data storage unit 107 to recognize a number of beats and an average sound pressure value. Also, the sound data analyzing unit 101 analyses the sound data of radio and the like to separate the music data and the voice (talk) data. Since the technique of separating the music data and the voice data is known, the description thereof will be omitted for the sake of convenience. The sound data analyzing unit 101 functions as the contents data analyzing unit of the present invention.

The volume information receiving unit 102 receives, via the network 2, volume information generated by a volume information generating unit 201 in the terminal unit 200. The volume information indicates the volume with which the sound reproducing terminal 12 reproduces the sound data.

The time zone detecting unit 103 specifies the time to reproduce the sound data by referring to the clock installed in the sound reproducing server 10. Further, the time zone detecting unit 103 detects the time zone to reproduce the sound data, based on the specified time, by referring to the time zone table stored in the ROM that the sound reproducing server 10 includes . In the time zone table, the time zone and the time are corresponded to each other. For example, in the time zone table, the time zone “Morning” is corresponded to the time “5 to 10 o'clock”, and the time zone “Night” is corresponded to the time “20 to 2 o'clock”. In this case, when the time zone detecting unit 103 specifies the time “8 o'clock”, it detects the time zone “Morning”. The correspondence of the time zone and the time in the time zone table may be arbitrarily set. The time zone detecting unit 103 functions as the time zone detecting unit of the present invention.

The person detecting information receiving unit 104 receives, via the network 2, the person detecting information generated by a person detecting information generating unit 203 in the terminal unit 200. The person detecting information is generated when the person detecting sensor, that the sound reproducing terminal 12 has, detects a person existing in a predetermined range from the sound reproducing terminal 12. Namely, the person detecting information indicates the presence/absence of a person in the predetermined range from the sound reproducing terminal 12, serving as a reference. Therefore, a positional relation, such as a distance, between the sound reproducing terminal 12 and the person may be calculated from plural person detecting information.

The delay amount calculating unit 105 calculates the amounts (delay amounts) of the sound data, respectively, when each of the sound reproducing terminals 12 reproduces the sound data. The delay amount is the time that the sound data is delayed, for example.

The first method by which the delay amount calculating unit 105 calculates the delay amount is based on the person detecting information received by the person detecting information receiving unit 104. Specifically, based on the distances between the sound reproducing terminal 12s and the person, calculated from plural person detecting information, the delay amount calculating unit 105 calculates the delay amount to be smallest for the sound data reproduced by the sound reproducing terminal 12 having a shortest distance from the person, and calculates the delay amount to be larger for the sound data reproduced by the sound reproducing terminal 12 having a longer distance from the person. Namely, the delay amount calculating unit 105 calculates the delay amount of the sound data reproduced by the sound reproducing terminal 12, based on the person detecting information, such that the delay amount is proportional to the distance between the person and the sound reproducing terminal 12.

It is conceivable that the delay amount calculating unit 105 refers to the distances between each of the sound reproducing terminals when the distance from the person to the sound reproducing terminal 12 is calculated. Namely, it is conceivable that the delay amount calculating unit 105 specifies the sound reproducing terminal 12, whose distance from the person is short, to calculate the delay amount, based on the plural person detecting information, and corrects the delay amount by referring to the distances between each of the sound reproducing terminals.

As a method of calculating the distances between each of the sound reproducing terminals, there are conceivable a method that each of the sound reproducing terminals 12 measures the distance by a sensor and a method that the listener inputs the value of the distance in advance. In a case that the distances between each of the sound reproducing terminals is measured by the sensor, each of the sound reproducing terminals 12 has a microphone and outputs a predetermined test sound. Then, the delay amount calculating unit 105 calculates the distances between each of the sound reproducing terminals 12 based on the timing at which each of the sound reproducing terminals 12 receives the test sound. Also, each of the sound reproducing terminals 12 may detect, by the sensor, the listener who is walking around, and the delay amount calculating unit 105 may recognize the sound reproducing terminals 12 neighboring to each other based on the detection result to calculate approximate distance between each of the sound reproducing terminals.

The second method by which the delay amount calculating unit 105 calculates the delay amount is a method based on the analysis result of the sound data by the sound data analyzing unit 101. Specifically, based on the analysis result by the sound data analyzing unit 101, the delay amount calculating unit 105 sets the delay amount of zero in the determination of the voice data, calculates a small delay amount for the contents data whose number of beats and the average sound pressure value are high and calculates a large delay amount for the contents data whose number of beats and the average sound pressure value are low in the determination of the music data. For example, the delay amount calculating unit 105 calculates the small delay amount for the sound data having strong beat, such as rock music, and calculates the large delay amount for the sound data having weak beat, such as classic music.

The third method by which the delay amount calculating unit 105 calculates the delay amount is a method based on the volume information that the volume information receiving unit 102 receives. Specifically, based on the volume information, the delay amount calculating unit 105 calculates a small delay amount for the sound data when the volume is large because it is supposed that the listener concentrating is listening, and calculates a large delay amount for the sound data when the volume is small because it is supposed that the listener is listening as BGM.

The fourth method by which the delay amount calculating unit 105 calculates the delay amount is a method based on the time zone that the time zone detecting unit 103 detects. Specifically, the delay amount calculating unit 105 calculates a small delay amount for the sound data, to supply refreshment to the listener, when the time zone detected by the time zone detecting unit 103 is “Morning”, and calculates a large delay amount for the sound data, to supply relaxation to the listener, when the time zone detected by the time zone detecting unit 103 is “Night”.

The fifth method by which the delay amount calculating unit 105 calculates the delay amount is a method based on the number of the sound reproducing terminals 12 that the sound reproducing system 1 has. Specifically, the delay amount calculating unit 105 calculates interval widths based on the number of the sound reproducing terminals 12, with using the maximum delay amount as a reference, to calculate the delay amount of the sound data reproduced by each of the sound reproducing terminals 12. The interval width may be arbitrarily set, e.g., determined by equally dividing the maximum delay amount or determined at random. The maximum delay amount may be set in advance, or may be calculated by each method to calculate the delay amount.

The sixth method by which the delay amount calculating unit 105 calculates the delay amount is a method in which the listener designates the delay amount. Specifically, the delay amount calculating unit 105 sets the delay amount (e.g., 40 ms), that the listener directly designated to each of the sound reproducing terminals 12, to the delay amount for the sound data reproduced by each of the sound reproducing terminals 12. The listener may designate “Large, Middle, Small” as the spreading effect, and the delay amount calculating unit 105 may calculate the delay amount of the sound data reproduced by each of the sound reproducing terminals 12 based on the designated level. Further, the delay amount calculating unit 105 may calculate the delay amount of the sound data reproduced by each of the terminal unit 12 such that all the sound reproducing terminals 12 in the sound reproducing system 1 do not have the same delay amount, when the listener designates the delay interval.

The delay amount calculating unit 105 calculates the delay amounts used when each of the sound reproducing terminals 12 reproduces the sound data, by combining the above-mentioned other methods with the first method. Then, the delay amount calculating unit 105 generates the delay amount information indicating the delay amount corresponding to each of the sound reproducing terminals 12. The delay amount calculating unit 105 functions as the delay amount calculating unit and the distance calculating unit in the present invention. It is noted that the “small delay amount” includes the delay amount of zero, i.e., without delay.

The delay amount information transmitting unit 106 transmits the delay amount information generated by the delay amount calculating unit 105 to each of the sound reproducing terminals 12 via the network 2. The delay amount information transmitting unit 106 functions as the delay amount information transmitting unit of the present invention.

The sound data storage unit 107 stores plural sound data to be reproduced by the sound reproducing terminals 12, and specifically it is configured by a HDD and a Flash memory installed in the sound reproducing server 10.

The sound data transmitting unit 108 extracts the sound data from the sound data storage unit 107, and transmits them to each of the sound reproducing terminals 12 via the network 2.

The above-mentioned elements are realized by the CPU of the sound reproducing server 10 which executes a program prepared in advance.

The server unit 100 may include the sound data analyzing unit 101, the volume information receiving unit 102 and the time zone detecting unit 103, in accordance with the method applied to the delay amount calculating unit 105.

[Terminal Unit]

The terminal unit 200 is substantially configured by the constitutional elements of the sound reproducing terminal 12. As shown, the terminal unit 200 includes a volume information generating unit 201, a volume information transmitting unit 202, a person detecting information generating unit 203, a person detecting information transmitting unit 204, a delay amount information receiving unit 205, a delay amount setting unit 206, a sound data receiving unit 207, a delay control unit 208 and a sound data reproducing unit 209.

The volume information generating unit 201 generates the volume information indicating the volume by which the sound data is reproduced. Normally, the volume is designated by the listener. The volume information generating unit 201 functions as the volume information generating unit of the present invention.

The volume information transmitting unit 202 transmits the volume information, generated by the volume information generating unit 201, to the sound reproducing server 10 via the network 2.

The person detecting information generating unit 203 generates the person detecting information when the person detecting sensor detects a person. The person detecting information generating unit 203 functions as the person detecting information generating unit of the present invention.

The person detecting information transmitting unit 204 transmits the person detecting information, generated by the person detecting information generating unit 203, to the sound reproducing server 10 via the network 2.

The delay amount information receiving unit 205 receives the delay amount information generated by the delay amount information generating unit 105 of the server unit 100 via the network 2.

The delay amount setting unit 206 sets the delay amount, indicated by the delay amount information received by the delay amount information receiving unit 205, to the delay control unit 208 as the delay amount used to reproduced the sound data. The timing when the delay amount setting unit 206 sets the delay amount may be the timing when the delay amount information receiving unit 205 receives the delay amount information (sometimes in the middle of the music piece), may be the transition of the music pieces reproduced from the sound data, or may be set by the listener in advance.

The sound data receiving unit 207 receives the sound data, extracted from the sound data storage unit 107 of the server unit 100, via the network 2.

The delay control unit 208 performs the control of delaying the sound data for amount corresponding to the delay amount set by the delay amount setting unit 206, when the sound data received by the sound data receiving unit 207 is reproduced.

The sound data reproducing unit 209 reproduces the sound data received by the sound data receiving unit 207, with the delay of the amount corresponding to the delay amount set in advance, based on the control of the delay control unit 208.

The delay amount setting unit 206, the delay control unit 208 and the sound data reproducing unit 209 are configured by the sound output unit. Also, the delay amount setting unit 206, the delay control unit 208 and the sound data reproducing unit 209 function as the sound reproducing unit of the present invention.

Each of the above-mentioned units are realized by the CPU of the sound reproducing terminal 12 which executes the program prepared in advance.

In addition, the terminal unit 200 may include the volume information generating unit 201 and the volume information transmitting unit 202, in accordance with the method applied to the delay amount calculating unit 105 of the server unit 100.

According to the sound reproducing system including the sound reproducing server 10 and the sound reproducing terminals 12 as described above, by automatically controlling the delay amount by various delay amount calculating methods, it is possible to provide the listener with a sound space having wrapped feeling and spreading feeling.

[Sound Reproducing Processing]

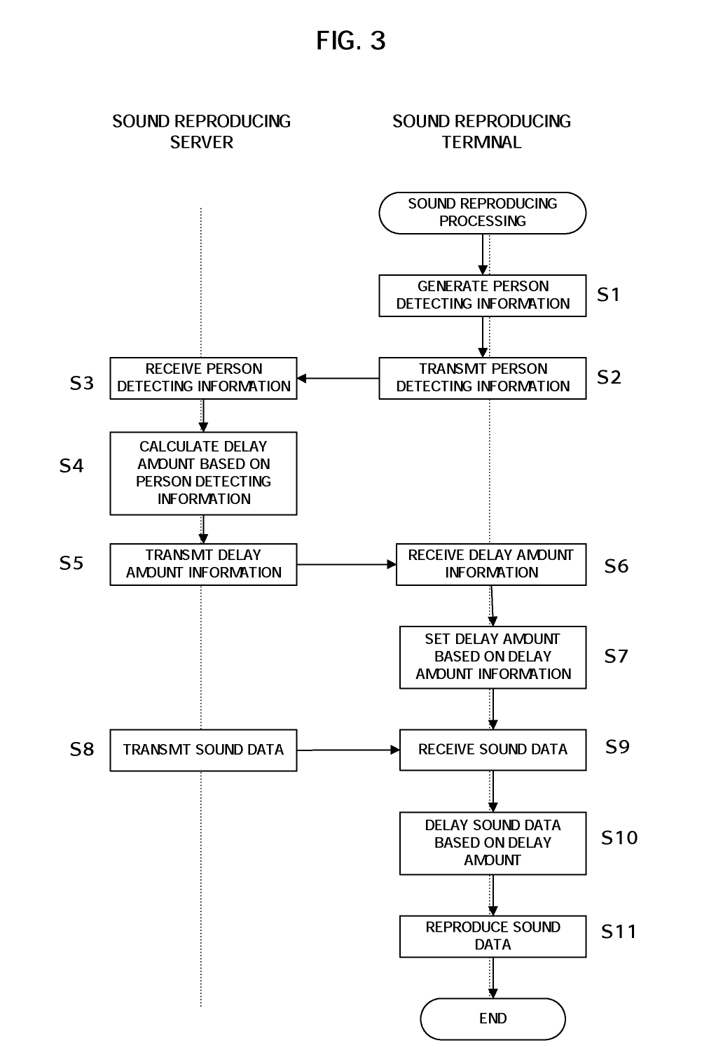

Next, the sound reproducing processing according to this embodiment will be described with reference to FIG. 3. FIG. 3 is a flowchart of the sound reproducing processing of this embodiment. The sound reproducing processing is a processing to control the delay amounts when the sound data stored in the sound reproducing server 10 is simultaneously reproduced by the plural sound reproducing terminals 12. In the sound reproducing processing of this embodiment, it is assumed that the delay amount calculating unit 105 of the server unit 100 calculates the delay amount based only on the first method, i.e., based only on the person detecting information. Also, it is assumed that the distances between each of the sound reproducing terminals 12 are inputted by the listener in advance, and the distance between the sound reproducing terminals 12a and 12c is longer than the distance between the sound reproducing terminals 12a and 12b.

When the listener moves to the sound reproducing terminal 12, the person detecting sensor of the sound reproducing terminal 12 detects the person, and the person detecting information generating unit 203 of the terminal unit 200 generates the person detecting information (step S1). For example, it is assumed that the listener moves to the position near the sound reproducing terminal 12a set in the living room. Then, the person detecting sensor of the sound reproducing terminal 12 detects the person, and the person detecting information generating unit 203 of the terminal unit 200 constituted by that sound reproducing terminal 12a generates the person detecting information indicating that a person exists in the predetermined range from the sound reproducing terminal 12a. Subsequently, the person detecting information transmitting unit 204 transmits the person detecting information generated by the person detecting information generating unit 203 to the sound reproducing server 10 via the network 2 (step S2).

The person detecting information receiving unit 104 receives the person detecting information from the sound reproducing terminal 12a via the network 2 (step S3). The delay amount calculating unit 105 calculates the distances between the sound reproducing terminals and the person from the plural person detecting information received by the person detecting information receiving unit 104, specifies that the sound reproducing terminal having a shortest distance from the person is the sound reproducing terminal 12a set in the living room, and calculates a smallest delay amount (e.g., 0 ms) for the sound data reproduced by the sound reproducing terminal 12a. Subsequently, the delay amount calculating unit 105 calculates a larger delay amount (e.g., 15 ms) for the sound data reproduced by the sound reproducing terminal 12b set in the dining room, based on the distances between each of the sound reproducing terminals. Further, the delay amount calculating unit 105 calculates a largest delay amount (e.g., 30 ms) for the sound data reproduced by the sound reproducing terminal 12c set in the kitchen, based on the distances between each of the sound reproducing terminals. Namely, based on the person detecting information and the distances between each of the sound reproducing terminals, the delay amount calculating unit 105 calculates the delay amount of the sound data reproduced by the sound reproducing terminal 12a having shortest distance from the person to be smallest, and the delay amounts of the sound data reproduced by the sound reproducing terminals 12b and 12c having longer distance from the person to be larger (step S4). Then, the delay amount calculating unit 105 generates the delay amount information indicating the delay amount of the sound data reproduced by each of the sound reproducing terminals 12. The delay amount information transmitting unit 106 transmits the delay amount information, generated by the delay amount calculating unit 105, to each of the sound reproducing terminals 12, respectively, via the network 2 (step S5).

The delay amount information receiving unit 205 of the sound reproducing terminal 12 receives the delay amount information from the sound reproducing server 10 via the network 2 (step S6). The delay amount setting unit 206 sets the delay amount, indicated by the delay amount information received by the delay amount information receiving unit 205, to the delay control unit 208 as the delay amount used to reproduce the sound data (step S7).

Also, the sound data transmitting unit 108 of the sound reproducing server 10 extracts the sound data from the sound data storage unit 107, and transmits the sound data to each of the sound reproducing terminals 12, respectively, via the network 2 (step S8). The sound data receiving unit 207 of the sound reproducing terminal 12 receives the sound data from the sound reproducing server 10 (step S9).

The delay control unit 208 of the sound reproducing terminal 12 performs the control of delaying the sound data by the amount corresponding to the delay amount set by the delay amount setting unit 206, when the sound data received by the sound data receiving unit 207 is reproduced (step S10). Then, the sound data reproducing unit 209 reproduces the sound data, received by the sound data receiving unit 207, with the delay corresponding to the delay amount set in advance, based on the control by the delay control unit 208 (step S11). Thus, the sound reproducing processing ends.

In the sound reproducing system 1 of this embodiment, both the delayed reproducing function and the person detecting sensor function are executed. However, the present invention is not limited to this feature. The listener may designate to execute or not to execute the delayed reproducing function and the person detecting sensor function. If the delayed reproducing function is designated not to be executed, it is conceivable that the listener designates the delay amount of each of the sound reproducing terminals 12. Also, if the person detecting sensor function is designated not to be executed, the sound reproducing system 1 can provide the listener with wrapped feeling and spreading feeling based on the volume and/or the time zone.

Further, in the sound reproducing system of this embodiment, the plural sound reproducing terminals 12 are set in different rooms in the house, respectively. However, the present invention is not limited to this feature. The plural sound reproducing terminals 12 may be set at different positions in a single room.

In a case that the above sound reproducing processing is executed, if the sound reproducing system 1 detects that the listener is close to the sound reproducing terminal 12a, the sound reproducing system 1 gives larger delay to the sound data reproduced by the other sound reproducing terminals 12b and 12c. Therefore, the listener is effectively provided with wrapped feeling and spreading feeling by the plural sound reproducing terminals 12. In other words, by dynamically changing the delay control of each of the sound reproducing terminals based on the position of the listener, it is possible to provide wrapped feeling and spreading feeling, without wrong feeling, no matter where the listener moves. In addition, since the sound reproducing terminals 12 do not use the effecter such as the reverberation and is configured only by a simple delay circuit, the sound reproducing system 1 can be realized with low cost.

### INDUSTRIAL APPLICABILITY

This invention can be used for various systems which output sound by a such content reproducing method that effectively provides wrapped feeling and spreading feeling by various delay amount calculating methods, when the contents data is simultaneously reproduced by a plurality of contents reproducing terminals.

1. A contents reproducing system including a plurality of contents reproducing units which reproduces contents data, comprising:
a delay amount calculating unit which calculates a delay amount of the contents data reproduced by each of the content reproducing units; and
a contents reproducing unit which reproduces the contents data in each of the content reproducing units, based on the delay amount calculated by the delay amount calculating unit,
wherein each of the contents reproducing units includes:
a person detecting sensor which detects a person existing within a predetermined range from the contents reproducing unit; and
a person detecting information generating unit which generates person detecting information when the person detecting sensor detects the person, and
wherein the delay amount calculating unit determines the delay amount of the contents data reproduced by the contents reproducing unit having a shortest distance from the person to be zero and calculates the delay amount of the contents data reproduced by the contents reproducing unit having a longer distance from the person to be larger, based on plural person detecting information.

2. The contents reproducing system according to claim 1,
wherein the delay amount calculating unit calculates the distance from the person to determine the delay amount when the person detecting sensor detects a movement of the person.

3. (canceled)

4. The contents reproducing system according to claim 1, further comprising a distance calculating unit which calculates the distances between each of the contents reproducing units,
wherein the delay amount calculating unit calculates the delay amount of the contents data reproduced by each of the contents reproducing units based on the distances between each of the contents reproducing units, calculated by the distance calculating unit, and the person detecting information.

5. The contents reproducing system according to claim 1, further comprising a contents data analyzing unit which analyses the contents data,
wherein the delay amount calculating unit determines the delay amount to be zero in a determination of voice data and calculates a smaller delay amount for the contents data, a beat number and an average sound pressure value of which is higher, and a larger delay amount for the contents data, the beat number and the average sound pressure value of which is lower, in the determination of music data, based on the result of the analysis by the contents data analyzing unit.

6. The contents reproducing system according to claim 1, further comprising a volume detecting unit which detects a volume with which the contents data are reproduced,
wherein the delay amount calculating unit calculates a smaller delay amount for the contents data reproduced by a larger volume and calculates a larger delay amount for the contents data reproduced by a smaller volume, based on the volume detected by the volume detecting unit.

7. The contents reproducing system according to claim 1, further comprising a time zone detecting unit which detects a time zone, based on a time when the contents data are reproduced, by referring to a table in which a morning time zone and a night time zone are corresponded to time, in advance,
wherein the delay amount calculating unit calculate a small delay amount for the contents data reproduced in the morning time zone and calculates a large delay amount, which is larger than the small delay amount, for the contents data reproduced in the night time zone, based on the time zone detected by the time zone detecting unit.

8. The contents reproducing system according to claim 1, wherein the delay amount calculating unit calculates the delay amount of the contents data reproduced by each of the contents reproducing units based on a number of the contents reproducing units.

9. The contents reproducing system according to claim 1, wherein the delay amount calculating unit calculates the delay amount of the contents data reproduced by each of the contents reproducing units based on the delay amount designated in advance.

10. A contents reproducing method executed by a contents reproducing system including a plurality of content reproducing units which reproduces contents data, comprising:
a delay amount calculating process which calculates delay amount of the contents data reproduced by each of the content reproducing units; and
a contents reproducing process which reproduces the contents data in each of the content reproducing units, based on the delay amount calculated by the delay amount calculating process
wherein each of the contents reproducing units includes:
a person detecting sensor which detects a person existing within a predetermined range from the contents reproducing unit; and
a person detecting information generating unit which generates person detecting information when the person detecting sensor detects the person, and
wherein the delay amount calculating process determines the delay amount of the contents data reproduced by the contents reproducing unit having a shortest distance from the person to be zero and calculates the delay amount of the contents data reproduced by the contents reproducing unit having a longer distance from the person to be larger, based on plural person detecting information.

11. A contents reproducing server which communicates with a plurality of content reproducing terminals which reproduces contents data, comprising:
a delay amount calculating unit which calculates delay amounts of the contents data reproduced by each of the contents reproducing units; and
a delay amount transmitting unit which transmits delay amount information related to the delay amount calculated by the delay amount calculating unit to each of the contents reproducing terminals,
wherein each of the contents reproducing terminals includes:
a person detecting sensor which detects a person existing within a predetermined range from the contents reproducing terminal; and
a person detecting information generating unit which generates person detecting information when the person detecting sensor detects the person, and
wherein the delay amount calculating unit determines the delay amount of the contents data reproduced by the contents reproducing terminal having a shortest distance from the person to be zero and calculates the delay amount of the contents data reproduced by the contents reproducing terminal having a longer distance from the person to be larger, based on plural person detecting information.

12. A contents reproducing program executed by a computer which communicates with a plurality of content reproducing terminals which reproduces contents data, the program making the computer function as:
a delay amount calculating unit which calculates delay amounts of the contents data reproduced by each of the content reproducing terminals; and
a delay amount transmitting unit which transmits delay amount information related to the delay amount calculated by the delay amount calculating unit to each of the contents reproducing terminals,
wherein each of the contents reproducing terminals includes:
a person detecting sensor which detects a person existing within a predetermined range from the contents reproducing terminal; and
a person detecting information generating unit which generates person detecting information when the person detecting sensor detects the person, and
wherein the delay amount calculating unit determines the delay amount of the contents data reproduced by the contents reproducing terminal having a shortest distance from the person to be zero and calculates the delay amount of the contents data reproduced by the contents reproducing terminal having a longer distance from the person to be larger, based on plural person detecting information.

13. A storage medium which stores the contents reproducing program according to claim 12.
